(19) United States
(12) Patent Application Publication
(10) Pub. No.: US 2010/0180331 A1
(43) Pub. Date: Jul. 15, 2010

(54) COMMUNICATION TERMINAL DEVICE, RULE DISTRIBUTION DEVICE, AND PROGRAM

(75) Inventors: Takuya Murakami, Tokyo (JP); Masashi Itoh, Tokyo (JP); Yoshiaki Okuyama, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC Corporation, Tokyo (JP)

(21) Appl. No.: 12/295,216

(22) PCT Filed: Feb. 9, 2007
(86) PCT No.: PCT/JP2007/052322

§ 371 Date: Sep. 29, 2008

(30) Foreign Application Priority Data
Mar. 30, 2006 (JP) 2006-093261

(51) Int. Cl. G06F 21/20; H04L 12/66; G06F 13/00; H04L 12/28

(52) U.S. Cl. 726/11

(57) ABSTRACT

A communication terminal device (10) that is provided with a communication device (11) that connects to a network and a firewall (12) that functions in accordance with firewall rules further includes: a rule storage unit (14) that holds network identification information and firewall rules in association with each other for each network; a rule storage control unit (15) that stores in the rule storage unit (14) firewall rules that are received from rule-distributing device (20) and the identification information of a network that is the object of application in association with each other; and a firewall control unit (13) that detects network identification information to both monitor and, when the identification information is newly detected or changes, reads from the rule storage unit (14) firewall rules that are placed in association with the identification information that has been detected or that has changed to set or update in the firewall (12).

### TECHNICAL FIELD

The present invention relates to a communication terminal device provided with a firewall and a program of the communication terminal device. The present invention further relates to a rule distribution device for distributing firewall rules to each communication terminal device and to a program of the rule distribution device.

### BACKGROUND ART

The popularization of wireless networks such as portable telephone networks and wireless LAN (Local Area Networks) in recent years has been accompanied by an increase in the cases of using mobile terminal devices to connect to a wide variety of networks.

Connecting a terminal to a wide variety of networks raises the concern of attacks upon the terminal device through the network by an intruder with malicious intent. One method of protecting against such attacks involves the provision of a personal firewall (hereinbelow referred to as a “firewall”) function in the terminal. A firewall monitors communication between the terminal and networks, and passes only necessary communication while blocking unnecessary communication. Therefore, it is possible to protect against illegitimate communication or attacks from the network side.

Conventionally, the firewall capability is generally provided as software in a personal computer and is not usually provided in a mobile communication terminal device such as a portable telephone. However, a mobile communication terminal device frequently switches connections with networks of differing security levels, and the firewall of a mobile communication terminal device therefore calls for a higher level of functionality than a personal firewall that is not expected to move appreciably. More specifically, when switching networks, the firewall rules must be quickly switched in accordance with the security level of the network that is being switched to.

In addition, most users of mobile terminal devices such as portable telephones are not expert regarding firewall settings, and it is therefore preferable that the provider of the portable telephone service make the firewall settings. In particular, the outbreak of a new type of computer virus or worm results in the increase of a specific attack in a short time period, and rules for defending against attacks must be quickly applied to the firewall of each communication terminal device to provide early defense against attacks.

(1) JP-A-2004-094723 (Patent Document 1) discloses a configuration in which, when a user's system submits a request for settings alteration data of a firewall to the system of a service provider, the system of the service provider transmits alteration data to the user's system to alter the firewall settings.

(2) JP-A-2005-191721 (Patent Document 2) discloses a wireless terminal device that is provided with functions of, when the terminal device lacks network setting information that corresponds to a network identifier detected by a wireless LAN network detection unit, using a wireless unit that differs from the wireless unit for connecting to the wireless LAN to access the directory server, download the network setting information of that wireless LAN, and register.

(3) JP-A-2005-031720 (Patent Document 3) discloses a firewall device that stores firewall rules for each user and switches firewall rules in accordance with connections.

Patent Document 1: JP-A-2004-094723

Patent Document 2: JP-A-2005-191721

Patent Document 3: JP-A-2005-031720

### DISCLOSURE OF THE INVENTION

### Problem to be Solved by the Invention

The settings alteration methods disclosed in Patent Documents 1 and 2 are both methods in which a service provider returns updating data in response to a request from a user and therefore cannot handle a case in which the urgent need arises to update firewall rules of each communication terminal device, such as in the event of the outbreak of a new type of computer virus or worm. Handling an emergency such as described above by the conventional methods would require constant and repeated polling from the user side and would increase the network load. In addition, considering that emergencies are not a normal state, such a solution would render the greater part of communication pointless.

It is an object of the present invention to enable the rapid updating of the firewall rules of each communication terminal device in an emergency such as the outbreak of a new type of computer virus.

In addition, the related art lacks a method by which the service provider, in the event of an attack upon a communication terminal device, quickly senses this attack or learns the attack pattern or network in which the attack is received. As a result, the response to, for example, a new type of network attack tends to be delayed.

It is an object of the present invention to quickly detect a network attack and enable a timely response such as the updating of firewall rules.

### Means for Solving the Problem

The present invention is configured as described below in (1) to (11).

(1) Configuration 1:

A communication terminal device is provided with a communication device for connecting to a network and a firewall for controlling the passage and blocking of data between its own device and a network in accordance with firewall rules that are set; wherein the communication terminal device includes:

a rule storage unit for holding identification information of networks and firewall rules in association with each other for each network;

a rule storage control unit for storing in the rule storage unit firewall rules received from a prescribed rule-distributing device in association with identification information of the networks to which these firewall rules are to be applied; and

a firewall control unit for detecting the identification information of a network to both monitor and, when identification information is newly detected or changes, reading from the rule storage unit firewall rules that are placed in association with the identification information that has changed or been detected to set or update to the firewall.

(2) Configuration 2:

In the communication terminal device in Configuration 1,when the identification information of a network has been placed in association with firewall rules that are received from a prescribed rule-distributing device, the rule storage control unit stores the identification information in the rule storage unit in association with the firewall rules, and when the identification information of a network has not been placed in association with the firewall rules, the rule storage control unit stores the identification information detected by the firewall control unit in the rule storage unit in association with the firewall rules.

(3) Configuration 3:

In the communication terminal device in Configuration 1, when firewall rules and network identification information are stored in association with each other in the rule storage unit, the firewall control unit compares the identification information with the currently detected identification information, and if the two match, reads the firewall rules that have been placed in association with the identification information from the rule storage unit to update the firewall rules that are set in the firewall to the firewall rules that were read.

(4) Configuration 4:

In the communication terminal device in Configuration 1, the rule storage control unit confirms that firewall rules are received from a prescribed rule-distributing device by verifying a prescribed electronic signature.

(5) Configuration 5:

In Configuration 1, the communication terminal device further includes: an attack detection unit for monitoring data received in the communication device to detect a network attack that matches a prescribed pattern; and

an attack notification unit for, when the attack detection unit detects a network attack, placing the identification information detected by the firewall control unit in association with pattern information of the network attack and transmitting the pattern information and the identification information addressed to a prescribed rule-distributing device.

(6) Configuration 6:

In the communication terminal device in Configuration 5, the attack notification unit adds an electronic signature that is requested by a prescribed rule-distributing device to pattern information of the network attack and then transmits the pattern information and the identification information.

(7) Configuration 7:

A rule-distributing device provided with a communication device for connecting to a network further includes:

a rule storage unit that holds network identification information and firewall rules in association with each other for each network;

a terminal device storage unit that holds, for each communication terminal device, data transmission destination information of communication terminal devices that are being managed; and

a rule notification unit for reading firewall rules from the rule storage unit, as necessary, placing the identification information of the network that is the object of application of the firewall rules in association with the firewall rules, and transmitting the firewall rules and the identification information addressed to communication terminal devices that are being managed.

(8) Configuration 8:

In the rule-distributing device in Configuration 7, the rule notification unit transmits the firewall rules and the identification information in addition to a prescribed electronic signature.

(9) Configuration 9:

In Configuration 7, the rule-distributing device further includes: a rule investigation unit for, based on network identification information and pattern information of a network attack that is received from a communication terminal device, investigating whether the network attack can be handled by the firewall rules that have been placed in correspondence with the identification information; and

a rule creation unit for, when the rule investigation unit has confirmed that a network attack cannot be handled, creating firewall rules that can handle the network attack;

wherein the rule notification unit places the network identification information in association with the firewall rules that the rule creation unit has produced and transmits the firewall rules and the identification information addressed to communication terminal devices that are being managed.

(10) Configuration 10:

A program causes a computer, which is provided with a communication device for connecting to a network and a firewall for controlling the passage or blockage of data between networks and the computer in accordance with firewall rules that are set, to function as:

a rule storage control unit for storing, in a rule storage unit that holds identification information of networks and firewall rules in association with each other for each network, firewall rules received from a prescribed rule-distributing device in association with the identification information of a network in which the firewall rules are to be applied; and

a firewall control unit for detecting the identification information of networks both to monitor and, when the identification information is newly detected or changes, reading from the rule storage unit firewall rules that have been placed in association with the identification information that has been detected or that has changed to set or update in the firewall.

(11) Configuration 11:

A program causes a computer, which is provided with a communication device for connecting to a network, to functions as:

a terminal device storage unit that holds data transmission destination information of communication terminal devices that are being managed for each communication terminal device; and

a rule notification unit for reading firewall rules from a rule storage unit that holds network identification information and firewall rules in association with each other for each network, as necessary, placing the identification information of a network that is the object of application of the firewall rules in association with the firewall rules, and transmitting the firewall rules and the identification information addressed to communication terminal devices that are being managed.

### Effect of the Invention

The communication terminal device of Configuration 1 is a communication terminal device provided with a communication device for connecting to a network and a firewall for controlling the passage and blockage of data between networks and its own device in accordance with firewall rules that are set, the communication terminal device including: a rule storage unit for holding, for each network, identification information of networks and firewall rules in association with each other; a rule storage control unit for storing, in the rule storage unit, firewall rules received from a prescribed rule-distributing device in association with the identification information of the network that is the object of application of the firewall rules; and a firewall control unit for detecting identification information of network to both monitor and, when identification information is newly detected or changes, reading the firewall rules that are placed in association with the identification information that has been detected or changed from the rule storage unit to set or update in the firewall. As a result, even in an emergency such as the outbreak of a new type of computer virus, it is possible to be received from the service provider side and to update the firewall rules quickly.

In the communication terminal device of Configuration 2, when identification information of a network has been placed in association with firewall rules that are received from a prescribed rule-distributing device, the rule storage control unit in Configuration 1 stores the identification information in the rule storage unit in association with the firewall rules, and when identification information of a network is not placed in association with the firewall rules, the rule storage control unit stores the identification information that is detected by the firewall control unit in the rule storage unit in association with the firewall rules.

As a result, in addition to the effect exhibited by Configuration 1, the effect exists that enables the conferring of an actual configuration regarding the association of network identification information.

In the communication terminal device of Configuration 3, when firewall rules and the identification information of a network are stored in association with each other in the rule storage unit, the firewall control unit in Configuration 1 compares the identification information with the identification information that is currently detected, and when the two items of identification information match, reads the firewall rules that are placed in association with the identification information from the rule storage unit and updates the firewall rules that are set in the firewall to the firewall rules that have been read. As a result, in addition to the effects exhibited by Configuration 1, the effect exists that, when firewall rules relating to the network that is currently connected have been updated, enables immediate setting of the firewall rules after updating.

In the communication terminal device of Configuration 4, the rule storage control unit in Configuration 1 confirms that firewall rules are received from a prescribed rule-distributing device by verifying a prescribed electronic signature. As a result, in addition to the effect exhibited by Configuration 1, the effect exists that enables confirmation that a firewall rule update is legitimate.

In the communication terminal device of Configuration 5, Configuration 1 further includes an attack detection unit for monitoring data received at the communication device to detect a network attack that matches a prescribed pattern, and an attack notification unit for, when the attack detection unit detects a network attack, placing the pattern information of the network attack and the identification information detected by the firewall control unit in association with each other and transmitting the pattern information and the identification information addressed to a prescribed rule-distributing device. As a result, the service provider (rule-distributing device) can, by means of information received from each communication terminal device, swiftly detect a new type of network attack to deal with the network attack.

In the communication terminal device of Configuration 6, the attack notification unit in Configuration 5 adds an electronic signature requested by a prescribed rule-distributing device and transmits the pattern information and the identification information. As a result, in addition to the effect exhibited by Configuration 5, the effect exists that enables the service provider (rule-distributing device) to confirm that a notification is legitimate.

The rule-distributing device of Configuration 7 is a rule-distributing device provided with a communication device for connecting to a network and includes: a rule storage unit that holds identification information of networks and firewall rules in association with each other for each network; a terminal device storage unit that holds data transmission destination information of communication terminal devices that are being managed for each communication terminal device; and a rule notification unit for reading firewall rules from the rule storage unit, as necessary placing the identification information of the network that is the object of application of the firewall rules in association with the firewall rules, and transmitting the firewall rules and the identification information addressed to communication terminal devices that are being managed. As a result, it is possible to swiftly update the firewall rules of each communication terminal device even in an emergency such as the outbreak of a new type of computer virus.

In the rule-distributing device of Configuration 8, the rule notification unit in Configuration 7 adds a prescribed electronic signature and transmits the firewall rules and the identification information. As a result, in addition to the effect exhibited by Configuration 7, the effect exists that enables confirmation that updating is legitimate.

In the rule-distributing device of Configuration 9, Configuration 7 further includes: a rule investigation unit for, based on network identification information and pattern information of a network attack received from a communication terminal device, investigating whether the network attack can be handled by the firewall rules that are placed in association with the identification information; and a rule creation unit for creating firewall rules that can handle the network attack when the rule investigation means recognizes that the network attack cannot be handled. The rule notification unit places the network identification information in association with the firewall rules created by the rule creation unit and transmits the firewall rules and the identification information addressed to communication terminal devices that are being managed. As a result, a new type of network attack can be detected swiftly based on information from each of the communication terminal devices, and a timely countermeasure such as updating of firewall rules can be implemented.

Configuration 10 is a program for causing a computer provided with a communication device for connecting to a network and a firewall for controlling the passage and blockage of data between networks and the computer in accordance with firewall rules that are set to function as: a rule storage control unit for storing, in a rule storage unit that holds identification information of networks and firewall rules in association with each other for each network, firewall rules received from a prescribed rule-distributing device in association with identification information of a network that is the object of application of the firewall rules; and a firewall control unit for detecting identification information of networks to both monitor and, when the identification information is newly detected or changes, reading from the rule storage unit the firewall rules that are placed in association with the identification information that has been detected or that has changed and setting or updating in the firewall. As a result, a program can be provided for causing a computer to function as the device of Configuration 1.

Configuration 11 is a program for causing a computer provided with a communication device for connecting to a network to function as: a terminal device storage unit that holds for each communication terminal device the data transmission destination information of communication terminal devices that are being managed; and a rule notification unit for reading firewall rules from the rule storage unit that holds network identification information and firewall rules in association with each other for each network, as necessary, placing the identification information of the network that is the object of application of the firewall rules in association with the firewall rules and transmitting the firewall rules and identification information addressed to communication terminal devices that are being managed. As a result, a program can be provided for causing a computer to function as the device of Configuration 7.

### BRIEF DESCRIPTION OF THE DRAWINGS

FIG. 1 is a function block diagram showing communication terminal device 10 and rule-distributing device 20 of an embodiment; and

FIG. 2 is an explanatory view showing the configuration of a rule table that is held in firewall rule database 14 of communication terminal device 10 and firewall rule database 24 of the rule-distributing device.

### EXPLANATION OF REFERENCE NUMBERS

10 communication terminal device
11 communication device
12 firewall
13 firewall adaptive control unit (firewall control unit)
14 firewall rule database (rule storage unit)
15 firewall storage control unit (firewall control unit)
18 network attack detection control unit (attack detection unit)
19 attack notification control unit (attack notification unit)
20 rule-distributing device
21 communication device
24 firewall rule database (rule storage unit)
25 rule notification control unit (rule notification unit)
26 communication terminal device database
28 rule creation unit (rule creation unit)
29 rule investigation unit (rule investigation unit)

### BEST MODE FOR CARRYING OUT THE INVENTION

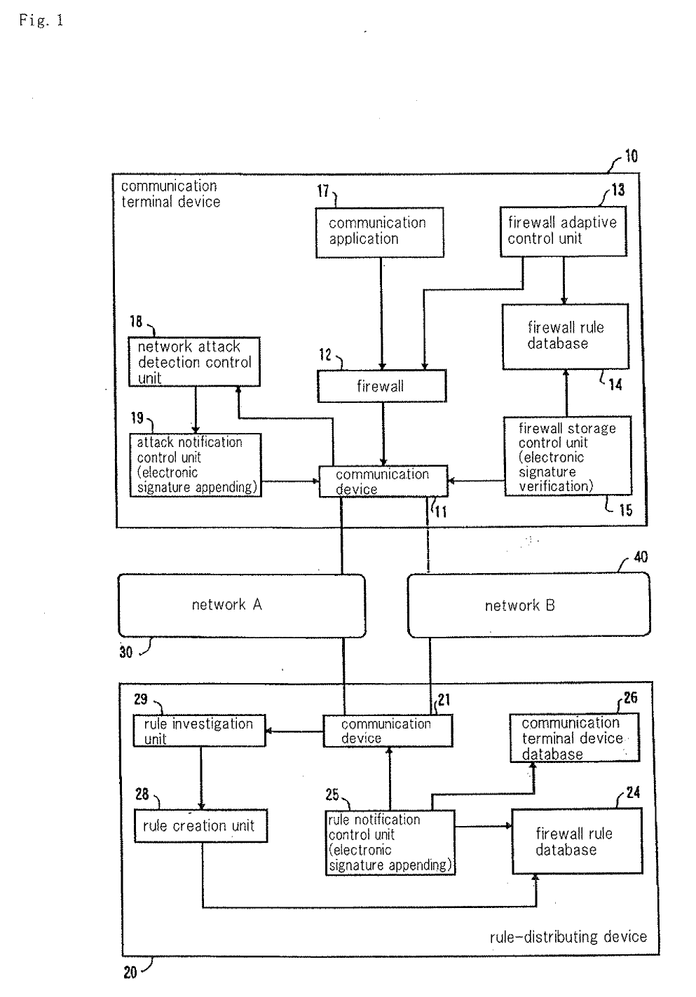

Explanation next regards an exemplary embodiment of the present invention with reference to the accompanying figures. FIG. 1 is a block diagram showing the configuration of communication terminal device 10 and rule-distributing device 20 of the exemplary embodiment of the present invention. In FIG. 1, communication terminal device 10 is a communication terminal device for connecting to network A30 or network B40 to receive a network service.

Network 30 and network 40 can be assumed to take various forms such as the Internet, an intranet, a wireless LAN spot, a LAN in a residence, and a LAN in a store.

Communication terminal device 10 uses communication device 11 to connect to network 30 and network 40. At such times, communication terminal device 10 connects to network 30 or network 40 by means of, for example, a wired LAN (Local Area Network), a wireless LAN, a public telephone network, a portable telephone network, a PHS (Personal Handy-phone System), an IrDA (Infrared Data Association), Bluetooth, or serial communication. The protocol used in communication is TCP/IP.

Firewall 12 is a means for defending against attacks from outside communication terminal device 10 by blocking unnecessary communication when using communication device 11 to communicate with network 30 or network 40. More specifically, firewall 12 checks the content of TCP/IP packets that pass through communication device 11 and blocks illegitimate communication by discarding unnecessary packets. Firewall rules indicating the type of communication that is to be blocked are set in firewall 12. The firewall rules are read from firewall rule database 14 by firewall adaptive control unit 13 and set in firewall 12. Firewall adaptive control unit 13 detects the identifier of the currently connected network (network 30 in FIG. 1) and reads the firewall rules that correspond to this identifier from firewall rule database 14 to set in firewall 12.

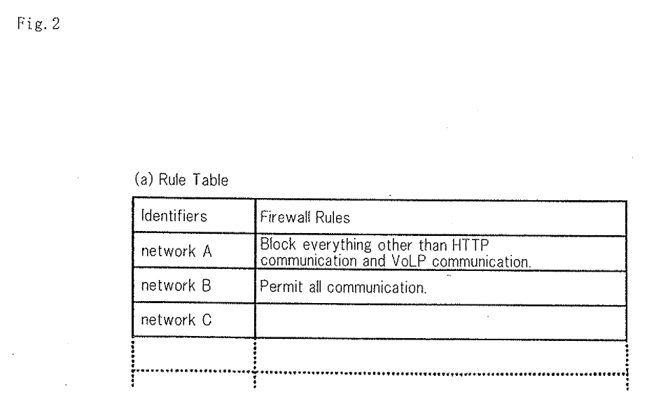

For this purpose, firewall rules are held in firewall rule database 14 for each network in association with network identifiers as shown in the rule table of FIG. 2(a). The identification name (access point name) of a cellular network, the ESS-ID (Extended Service Set Identifier) of a wireless LAN, or the network IP address can be used as the network identifier.

In the present invention, the firewall rules are designated by distributing device 20, which is the service-provider side. In other words, rule notification control unit 25 of rule-distributing device 20 manages the firewall rules, as necessary, reads from communication terminal device database 26 the address of each communication terminal device 10 that is being managed, and uses the addresses to distribute the firewall rules. In the exemplary embodiment, rule-distributing device 20 is provided in common to network 30 and network 40, but as an alternative, rule-distributing devices 20 may be provided for each network.

In FIG. 1, the firewall rules are distributed to communication terminal devices using network 30 or network 40. In communication terminal device 10, firewall storage control unit 15 receives these firewall rules by way of communication device 11 and registers these firewall rules in firewall rule database 14. An electronic signature is conferred to the firewall rules, and a signature verification control unit (electronic signature verification unit) in firewall rule storage control unit 15 verifies this signature.

A configuration can also be adopted in which the firewall rules are received from a network that differs from the network that is actually communicating. For example, a configuration can be adopted in which, when a wireless LAN is being used to communicate, electronic mail of a portable telephone network is used to receive the firewall rules for the wireless LAN.

Explanation next regards the detection and notification of a network attack.

In addition to the configuration of described hereinabove, communication terminal device 10 further includes network attack detection control unit 18 and attack notification control unit 19, and attack notification control unit 19 is equipped with a function for appending electronic signatures.

Network attack detection control unit 18 detects a network attack that is being carried out upon communication device 11. This component is typically referred to as an IDS (Intrusion Detection System), and is a component that compares the content of communication packets with patterns of network attack packets to determine whether there is matching between the two and thus detect an attack.

When network attack detection control unit 18 detects an attack, attack notification control unit 19 transmits a notification of this attack to rule investigation unit 29 of rule-distributing device 20. The electronic signature appending function of attack notification control unit 19 adds an electronic signature to this notification.

Rule investigation unit 29 of rule-distributing device 20 examines the pattern and incidence of network attack packets, according to necessity, causes rule creation unit 28 to create or amend the firewall rules that are to be placed in correspondence with that network, and updates the data of firewall rule database 24. Rule investigation unit 29 also verifies the electronic signature.

Explanation next regards the operation.

When the power supply is applied to communication terminal device 10, communication terminal device 10 uses communication device 11 to connect to a network. A case is here described in which communication terminal device 10 connects to network 30. When communication terminal device 10 is connected to network 30, communication application 17 begins communication. At this time, firewall 12 operates to block unnecessary communication. In addition, firewall storage control unit 15 enters a standby state to enable reception of firewall rules from rule-distributing device 20 at any time.

When firewall rules are updated in rule-distributing device 20, rule notification control unit 25 of rule-distributing device 20 transmits the firewall rules that have been updated to communication terminal device 10 by way of the network. Here, rule notification control unit 25 is assumed to transmit firewall rules to communication terminal device 10 by way of network 30.

At this time, a method can be considered in which rule notification control unit 25 distributes firewall rules by directly transmitting IP packets of firewall rules to firewall rule storage control unit 15 in communication terminal device 10 or by appending the firewall rules to electronic mail and then transmitting.

In communication terminal device 10, firewall rule storage control unit 15 receives the firewall rules by way of communication device 11. Firewall rule storage control unit 15 uses the electronic signature verification unit to verify the electronic signature of the firewall rules that are received. This electronic signature verification unit holds the server certificate of rule-distributing device 20 or a certificate of the Certification Authority (CA) and uses this certificate to verify the electronic signature. lf, as a result of verification, it is found that a legitimate electronic signature is not appended, firewall rule storage control unit 15 discards the firewall rules.

On the other hand, if as a result of verification it is found that a legitimate electronic signature is appended, firewall rule storage control unit 15 stores the firewall rules in firewall rule database 14. At this time, if a network identifier is appended to the firewall rules, firewall rule storage control unit 15 stores the firewall rules in firewall rule database 14 in association with this identifier. Adopting this configuration enables setting of firewall rules according to network. In addition, when a network identifier is not appended, firewall rule storage control unit 15 takes the network by which the firewall rules were received, i.e., network 30 in this example, as the identifier and stores firewall rules in firewall rule database 14 in association with this network, whereby firewall rules that correspond to the network that is currently connected can be set. A configuration that realizes processing in this way is useful when rule-distributing devices 20 are provided for each network. When the firewall rules that have been newly stored are rules for the network that is currently connected, and when, for example, firewall rules and network identification information are stored in association with each other in firewall rule database 14 and firewall adaptive control unit 13 compares this identification information with identification information that is currently detected and finds matching between the two, firewall adaptive control unit 13 next reads the newly stored firewall rules from firewall rule database 14 and updates the firewall rules that are set in firewall 12 to the firewall rules that have been read. Firewall 12 then carries out processing to block communication in accordance with the firewall rules that have been updated.

Explanation next regards a case in which communication terminal device 10 switches the network that is the connection destination.

When communication device 11 switches the connection destination network from network 30 to network 40, firewall rule adaptive control unit 13 detects this switch, reads the firewall rules that are placed in association with the identifier of network 40 from firewall rule database 14, and updates the firewall rules that are set in firewall 12 to the firewall rules that were read. Firewall 12 then blocks communication in accordance with the firewall rules after this switch.

In this way, control is implemented to dynamically switch firewall rules that are suitable to the connection destination network.

Explanation next regards the operation at the time of detecting a network attack.

Network attack detection control unit 18 is activated when communication terminal device 10 is connected to a network. Network attack detection control unit 18 closely examines packets that pass through communication device 11 to find packets that match the characteristics (a prescribed pattern) of attack packets. Upon discovery of a packet that matches, attack notification control unit 19 uses the electronic signature appending function to append an electronic signature to that packet (network attack pattern information) and transmits the packet to which the electronic signature has been appended via the network to rule investigation unit 29 of rule-distributing device 20. At this time, attack notification control unit 19 also places the identifier that indicates the network in which the attack was detected in association and transmits it. In the electronic signature appending function, the electronic signature requested by rule-distributing device 20 is appended.

Upon receiving the report of a network attack, rule investigation unit 29 of rule-distributing device 20 first verifies the electronic signature, and if the electronic signature is illegitimate, discards the report. On the other hand, if the report is legitimate, rule investigation unit 29 accepts the report and according to this information, collects statistics of attacks in each network. For example, rule investigation unit 29 collects the statistics that in network 30, attacks upon the 80^{th} TCP port have occurred in 20% of all communication terminal devices.

Rule creation unit 28 of rule-distributing device 20 can use the above-described information to effectively create firewall rules. The firewall rules that are created are recorded in firewall rule database 24 and distributed to each communication terminal device 10 by rule notification control unit 25. In addition, the above-described statistical information may be monitored by an administrator and the firewall rules then manually updated, or the firewall rules may be automatically updated by rule creation unit 28.

Explanation next regards the effect of the exemplary embodiment.

In the above-described exemplary embodiment, the ability for rule-distributing device 20 to transmit firewall rules to communication terminal device 10 to bring about updating can facilitate the centralized control of each communication terminal device 10 by rule-distributing device 20 and enables the swift distribution of firewall rules even in an emergency such as the outbreak of a new type of computer virus.

In addition, in contrast to a method in which each communication terminal device 10 requests and downloads firewall rules, rule-distributing device 20 in the present method transmits firewall rules to each communication terminal device 10, whereby the overall amount of communication can be reduced and the load on rule-distributing device 20 can also be reduced.

Still further, each communication terminal device 10 can dynamically switch firewall rules according to the connection destination network, thereby enabling the use of the optimum firewall settings for the security state of a network.

In the exemplary embodiment, information relating to attacks that is transmitted in from each communication terminal device 10 is investigated by rule investigation unit 29 of rule-distributing device 20 to enable the collection of information regarding the nature of the attacks and the networks on which each communication terminal device 10 is receiving an attack, i.e., the type of attacks that are occurring for each network. As a result, the optimum firewall rules of firewalls for each network can be manually or automatically updated and rapidly distributed to terminals.

Communication terminal device 10 may be a computer that operates in accordance with a program. This computer is provided with communication device 11, firewall 12, and firewall rule database 14. In addition, through the execution of this program, this computer functions as firewall storage control unit 15, firewall adaptive control unit 13, network attack detection control unit 18, and attack notification control unit 19.

Rule-distributing device 20 may also be a computer that operates in accordance with a program. This computer is provided with communication device 21 and firewall rule database 24. Through the execution of this program, this computer functions as rule investigation unit 29, rule creation unit 28, and rule notification control unit 25. In the exemplary embodiment as described hereinabove, the configuration shown in the figures is shown by way of example, and the present invention is not limited to this configuration.

1. A communication terminal device provided with a communication device that connects to a network and a firewall that controls passage and blocking of data between its own device and the network in accordance with firewall rules that are set; said communication terminal device comprising:
a rule storage unit that holds identification information of networks and firewall rules in association with each other for each network;
a rule storage control unit that stores in said rule storage unit firewall rules received from a prescribed rule-distributing device in association with identification information of networks to which these firewall rules are to be applied; and
a firewall control unit that detects identification information of a network to both monitor and, when the identification information is newly detected or changes, and reads from said rule storage unit firewall rules that are placed in association with the identification information that has been detected or has changed to set or update to said firewall.

2. The communication terminal device according to claim 1, wherein, when identification information of a network has been placed in association with firewall rules that are received from a prescribed rule-distributing device, said rule storage control unit stores the identification information in said rule storage unit in association with the firewall rules, and when identification information of a network has not been placed in association with said firewall rules, said rule storage control unit stores identification information detected by said firewall control unit in said rule storage unit in association with said firewall rules.

3. The communication terminal device according to claim 1, wherein, when firewall rules and network identification information are stored in association with each other in said rule storage unit, said firewall control unit compares the identification information with currently detected identification information, and if the two match, reads firewall rules that have been placed in association with the identification information from said rule storage unit to update the firewall rules that are set in said firewall to the firewall rules that were read.

4. The communication terminal device according to claim 1, wherein said rule storage control unit confirms that firewall rules are received from a prescribed rule-distributing device by verifying a prescribed electronic signature.

5. The communication terminal device according to claim 1, further comprising:
an attack detection unit that monitors data received in said communication device to detect a network attack that matches a prescribed pattern; and
an attack notification unit that, when said attack detection unit detects a network attack, places identification information detected by said firewall control unit in association with pattern information of the network attack and transmits the pattern information and the identification information addressed to a prescribed rule-distributing device.

6. The communication terminal device according to claim 5, wherein said attack notification unit appends an electronic signature that is requested by a prescribed rule-distributing device to said pattern information of a network attack and then transmits the pattern information.

7. A rule-distributing device provided with a communication device that connects to a network, said rule-distributing device comprising:
a rule storage unit that holds network identification information and firewall rules in association with each other for each network;
a terminal device storage unit that holds, for each communication terminal device, data transmission destination information of communication terminal devices that are being managed; and
a rule notification unit that reads firewall rules from said rule storage unit, and according to necessity, places identification information of a network that is the object of application of firewall rules in association with the firewall rules and transmits the firewall rules and the identification information addressed to communication terminal devices that are being managed.

8. The rule-distributing device according to claim 7, wherein said rule notification unit transmits said firewall rules and said identification information in addition to a prescribed electronic signature.

9. The rule-distributing device according to claim 7, further comprising:
a rule investigation unit that, based on network identification information and pattern information of a network attack that is received from a communication terminal device, investigates whether the network attack can be handled by firewall rules that have been placed in association with the identification information; and
a rule creation unit that, when said rule investigation unit has confirmed that the network attack cannot be handled, creates firewall rules that can handle the network attack;
wherein said rule notification unit places the network identification information in association with firewall rules that said rule creation unit has created and transmits the firewall rules and the identification information addressed to communication terminal devices that are being managed.

10. A computer readable recording medium in which a program is embedded, the program causing a computer that is provided with a communication device that connects to a network and a firewall that controls passage or blockage of data between networks and the computer in accordance with firewall rules that are set, to function as:
a rule storage control unit that stores, in a rule storage unit that holds identification information of networks and firewall rules in association with each other for each network, firewall rules received from a prescribed rule-distributing device in association with the identification information of a network in which the firewall rules are to be applied; and
a firewall control unit that detects identification information of networks both to monitor and, when the identification information is newly detected or changes, reads from said rule storage unit firewall rules that have been placed in association with the identification information that has been detected or that has changed to set or update in said firewall.

11. A computer readable recording medium in which a program is embedded, the program causing a computer that is provided with a communication device that connects to a network to functions as:
a terminal device storage unit that holds, for each communication terminal device, data transmission destination information of communication terminal devices that are being managed; and
a rule notification unit that reads firewall rules from a rule storage unit that holds network identification information and firewall rules in association with each other for each network, and according to necessity, places the identification information of a network that is the object of application of the firewall rules in association with the firewall rules and transmits the firewall rules and the identification information addressed to communication terminal devices that are being managed.

12. A communication terminal device provided with a communication device that connects to a network and a firewall that controls passage and blocking of data between its own device and the network in accordance with firewall rules that are set; said communication terminal device comprising:
rule storage means for holding identification information of networks and firewall rules in association with each other for each network;
rule storage control means for storing in said rule storage means firewall rules received from a prescribed rule-distributing device in association with identification information of networks to which these firewall rules are to be applied; and
firewall control means for detecting identification information of a network to both monitor and, when the identification information is newly detected or changes, and reading from said rule storage means firewall rules that are placed in association with the identification information that has been detected or has changed to set or update to said firewall.

13. A rule-distributing device provided with a communication device that connects to a network, said rule-distributing device comprising:
rule storage means for holding network identification information and firewall rules in association with each other for each network;
terminal device storage means for holding, for each communication terminal device, data transmission destination information of communication terminal devices that are being managed; and
rule notification means for reading firewall rules from said rule storage means, and according to necessity, placing identification information of a network that is the object of application of firewall rules in association with the firewall rules and transmits the firewall rules and the identification information addressed to communication terminal devices that are being managed.
